(19) United States
(12) Patent Application Publication
(10) Pub. No.: US 2024/0246380 A1
(43) Pub. Date: Jul. 25, 2024

(54) SHOCK ABSORBER CROSSOVER BUMPER

(71) Applicant: Polaris Industries Inc., Medina, MN (US)

(72) Inventors: Jake Edward Wendt, West Saint Paul, MN (US); Christopher Aaron Weyer, Wyoming, MN (US); Alex Scheuerell, Wyoming, MN (US); Nicholas Kurt Otto, Milltown, WI (US)

(21) Appl. No.: 18/415,844

(22) Filed: Jan. 18, 2024

Related U.S. Application Data
(60) Provisional application No. 63/439,900, filed on Jan. 19, 2023.

(51) Int. Cl. B60G 13/00

(52) U.S. Cl. CPC B60G 13/005

(57) ABSTRACT

A crossover bumper for damping noise in a dual-spring shock absorber that includes a spring coupler and a crossover ring. The crossover bumper includes a first ring having a first material forming a ring-shaped body that includes a first side and a second side facing opposite to the first side, and that defines a central opening, an inside diameter and an outside diameter; and a second ring attached to the first side of the first ring and including a second material forming a ring-shaped body defining a central opening aligned with the central opening of the first ring, an inside diameter and an outside diameter. The first material has a modulus of elasticity that is greater than a modulus of elasticity of the second material.

### RELATED APPLICATIONS

This application claims priority to U.S. Provisional Application No. 63/439,900 filed on Jan. 19, 2023, entitled Shock Absorber Crossover Bumper, the contents of which is expressly incorporated by reference herein.

### FIELD OF THE DISCLOSURE

This disclosure relates generally to shock absorbers for vehicles, and more specifically to devices, systems and methods for damping dual-spring shock absorbers with crossover rings.

### BACKGROUND

On dual-spring coil-over shocks mounted on vehicles, including off-road vehicles, there is a crossover ring that is used to change the effective spring rate of the vehicle's coil over. When the main spring hits the crossover ring, the spring rate changes from the combined spring rate of the main and tender springs, to only using the main spring. The component that separates the two springs is called a spring coupler. During compression, the spring coupler hits the crossover ring and at this point, the tender spring is not used as the shock continues to move in compression. Typically, the cross over-ring consists of two threaded rings that thread onto the shock body. Their position on the shock body determines when the spring coupler hits the crossover ring. Two crossover rings may be used as jam nuts to lock them together and prevent movement. The problem with this technology is that the spring coupler is typically made of a rigid glass filled nylon (PA 6,6 GF 10%) and the cross over ring is often aluminum. When the spring coupler strikes the aluminum crossover ring, often at speeds of 100 in/s or greater, a loud noise that most consumers dislike is generated.

Further, when the springs contact the crossover ring, an exterior portion of the crossover ring may suffer minor surface damage or marks from the contact with the springs.

### SUMMARY

Embodiments of the present disclosure include various devices, systems and methods that minimize the undesirable noise made when the spring coupler contacts that crossover ring and prevents or minimizes contact between the crossover ring and the shock absorber springs.

An embodiment of the disclosure includes a crossover bumper for damping noise in a dual-spring shock absorber that includes a spring coupler and a crossover ring, comprising: a first ring comprising a first material forming a ring-shaped body that includes a first side and a second side facing opposite to the first side, and that defines a central opening, an inside diameter and an outside diameter; and a second ring attached to the first side of the first ring and comprising a second material forming a ring-shaped body defining a central opening aligned with the central opening of the first ring, an inside diameter and an outside diameter; wherein the first material has a modulus of elasticity that is greater than a modulus of elasticity of the second material.

Another embodiment of the disclosure includes a crossover bumper for damping noise in a dual-spring shock absorber that includes a shock body, a spring coupler and a crossover ring, comprising: a backer ring comprising a first material forming a ring-shaped body that includes a first side and a second side facing opposite to the first side, and that defines a first central opening, an inside diameter and an outside diameter, the first central opening configured to receive the shock body with the second side in contact with the crossover ring; and a damper ring attached to the first side of the backer ring and comprising a second material forming a ring-shaped body defining a second central opening, an inside diameter and an outside diameter, the inside diameter being less than an outside diameter of the shock body, the second central opening configured to receive the shock body and hold the backer ring and damper ring on the shock body via friction fit.

Another embodiment of the disclosure includes a crossover bumper for damping noise in a dual-spring shock absorber that includes a shock body, a spring coupler and a crossover ring, comprising: a first multi-portion backer ring comprising a first material, including: a first semi-circular portion having a first end and a second end, and a second semi-circular portion having a first end and a second end, the first end of the second semi-circular portion connectable to the first end of the first semi-circular portion, and the second end of the second semi-circular portion connectable to the second end of the first semi-circular portion, such that the first semi-circular portion and the second semi-circular portion are connectable to form a ring shape; and a second multi-portion damper ring comprising a second material, the second material being different from the first material, the second multi-portion including: a first semi-circular portion configured to connect to the first semi-circular portion of the first multi-portion ring, and a second semi-circular portion configured to connect to the second semi-circular portion of the first multi-portion ring.

Another embodiment of the disclosure includes a crossover bumper for damping noise in a dual-spring shock absorber that includes a shock body, a spring coupler and a crossover ring, comprising: a first semi-circular portion that includes a first semi-circular backer portion and a first semi-circular damper portion, the first semi-circular backer portion including a first end and a second end, the first semi-circular damper portion attached to the first semi-circular backer portion; a second semi-circular portion that includes a second semi-circular backer portion and a second semi-circular damper portion, the second semi-circular backer portion including a first end and a second end, the second semi-circular damper portion attached to the first semi-circular backer portion; wherein the first end of the first semi-circular backer portion is connectable to the first end of the second semi-circular backer portion and the second end of the first semi-circular backer portion is connectable to the second end of the second semi-circular backer portion, such that the first semi-circular portion is connectable to the second semi-circular portion to form a ring shape for fitment onto the shock absorber.

Another embodiment of the disclosure includes a damping crossover ring for a dual-spring shock absorber, comprising: a first threaded ring comprising a polymer material and including a first surface, and defining a first outer diameter; and a damper ring connected to the first surface of the first threaded ring and comprising an elastomeric material, the damper ring defining a first outer diameter and a split between a first end and a second end.

Another embodiment of the disclosure includes a damping spring coupler for a dual-spring shock absorber, comprising: a spring coupler portion for coupling a first spring and a second spring of the dual-shock absorber, including: a body portion having a first end and a second end, the second end having an end surface, the body portion defining a central channel; a ring portion between the first end and the second end; and a damper ring affixed to the end surface of the second end of the body portion.

### BRIEF DESCRIPTION OF THE DRAWINGS

The disclosure can be understood in consideration of the following detailed description of various embodiments in connection with the accompanying drawings, in which:

FIG. 1 is a front view of a shock absorber, according to an embodiment of the disclosure;

FIG. 2 is a front view of the shock absorber of FIG. 1, with the springs removed;

FIG. 3 is a front view of the shock absorber of FIG. 1, with the springs and crossover bumper removed;

FIG. 4 is a front view of a tender spring of the shock absorber of FIG. 1, according to an embodiment of the disclosure;

FIG. 5 is a front view of a main spring of the shock absorber of FIG. 1, according to an embodiment of the disclosure;

FIG. 6 is a spring coupler of the shock absorber of FIG. 1, according to an embodiment of the disclosure;

FIG. 7 is a front view of the spring coupler of FIG. 6;

FIG. 8 is a perspective view of a crossover ring, according to an embodiment of the disclosure;

FIG. 9 is a front view of the crossover ring of FIG. 8;

FIG. 10 is a perspective view of a crossover bumper, according to an embodiment of the disclosure;

FIG. 11 is a top view of the crossover bumper of FIG. 10;

FIG. 12 is an exploded view of the crossover bumper of FIG. 10;

FIG. 13 is a front view of the crossover bumper of FIG. 10;

FIG. 14 is a rear view of the crossover bumper of FIG. 10;

FIG. 15 is a cross-sectional view of a damper ring of the crossover bumper of FIG. 10, according to an embodiment of the disclosure;

FIG. 16 is a perspective view of an overmolded crossover bumper, according to an embodiment of the disclosure;

FIG. 17 is a top view of the crossover bumper of FIG. 16;

FIG. 18 is an exploded view of the crossover bumper of FIG. 16;

FIG. 19 is a front view of the crossover bumper of FIG. 16;

FIG. 20 is a rear or side view of the crossover bumper of FIG. 16;

FIG. 21 is a perspective view of a multi-piece crossover bumper, according to an embodiment of the disclosure;

FIG. 22 is a top view of the crossover bumper of FIG. 21

FIG. 23 is an exploded view of the crossover bumper of FIG. 21;

FIG. 24 is a front view of the crossover bumper of FIG. 21;

FIG. 25 is a side view of the crossover bumper of FIG. 21;

FIG. 26 is another perspective view of the crossover bumper of FIG. 21;

FIG. 27 is a top view of the crossover bumper of FIG. 26, depicted with only one of two portions of a damper ring;

FIG. 28 is a perspective view of a first portion of the crossover bumper of FIG. 21;

FIG. 29 is a perspective view of a second portion of the crossover bumper of FIG. 21;

FIG. 30 is a cross-sectional view of the first portion of the crossover bumper of FIG. 28;

FIG. 31 is a perspective view of a crossover bumper formed as a jam nut of a crossover ring, according to an embodiment of the disclosure;

FIG. 32 is a top view of the crossover bumper of FIG. 31;

FIG. 33 is an exploded view of the crossover bumper of FIG. 31;

FIG. 34 is a front view of the crossover bumper of FIG. 31;

FIG. 35 is a side view of the crossover bumper of FIG. 31;

FIG. 36 is a cross-sectional view of the crossover bumper of FIG. 31;

FIG. 37 is a perspective view of a damping crossover ring, according to an embodiment of the disclosure;

FIG. 38 is a top view of the damping crossover ring of FIG. 37;

FIG. 39 is an exploded view of the damping crossover ring of FIG. 37;

FIG. 40 is a front view of the damping crossover ring of FIG. 37;

FIG. 41 is a side view of the damping crossover ring of FIG. 37;

FIG. 42 is a perspective view of a damping spring coupler, according to an embodiment of the disclosure;

FIG. 43 is an exploded view of the damping spring coupler of FIG. 42;

FIG. 44 is a front view of the damping spring coupler of FIG. 42;

FIG. 45 is a top view of the damping spring coupler of FIG. 42; and

FIG. 46 is a side view of the damping spring coupler of FIG. 42.

### DETAILED DESCRIPTION

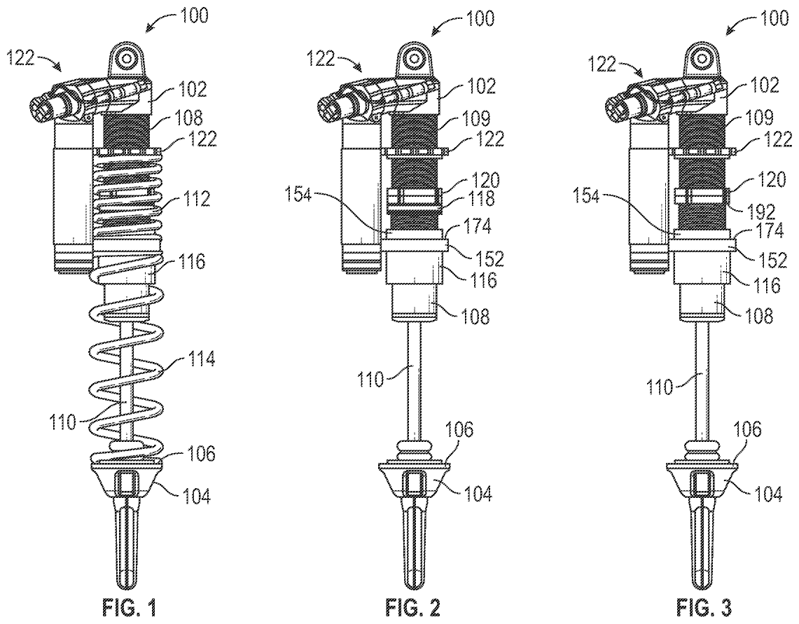

FIG. 1 depicts dual-spring coil-over shock absorber 100, according to an embodiment of the disclosure; FIG. 2 depicts shock absorber 100 with springs removed; and FIG. 3 depicts shock absorber 100 with springs and crossover ring removed, as explained further below.

Referring to FIGS. 1-3, shock absorber 100 includes first or upper end 102, second or lower end 104 with lower spring seat 106, body 108 having a portion with optional threads 109, moveable piston rod 110, first or upper or tender spring 112, second or lower or main spring 114, spring coupler 116, crossover bumper 118, crossover ring 120 and adjustable collar 122. In an embodiment, shock absorber 100 may also include damping adjusting system 124, as depicted.

Body 108, in an embodiment is generally cylindrical and may include a lower-non-threaded portion and an upper threaded portion with external threads 109. As will be understood by those of ordinary skill in the art, body 108 defines a cavity that houses a piston connected to piston rod 110, fluid, valves, and other components of shock absorbers as known in the art.

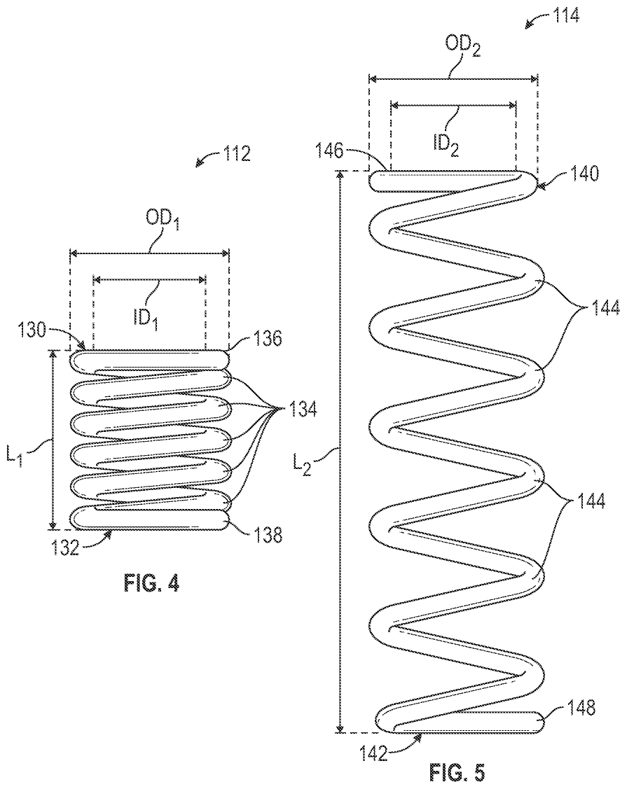

Referring to FIG. 4, an embodiment of tender spring 112 is depicted. Tender spring 112 includes first or upper end 130, second or lower end 132 and a plurality of coils 134, including top first or uppermost coil 136 and second or lowermost coil 138.

In an uncompressed state, tender spring 112 may define length L₁, outside diameter D₁ and inside diameter ID₁.

Referring to FIG. 5, an embodiment of tender spring 112 is depicted. Main spring 114 includes first or upper end 140, second or lower end 142 and a plurality of coils 144, including top first or uppermost coil 146 and second or lowermost coil 148.

In an uncompressed state, tender spring 114 may define length L₂ outside diameter OD₂ and inside diameter ID₂.

Referring to both FIGS. 4 and 5, in an embodiment, tender spring 112 length L₁ may be less than length L₂ of main spring 114. In another embodiment, lengths L₁ and L₂ may be substantially equal. In an embodiment, tender spring outside diameter OD₁ may be substantially the same as outside diameter OD₂ of main spring 114; tender spring inside diameter ID₁ may be substantially the same as inside diameter ID₂ of main spring 114. In other embodiments, the inside and outside diameters of springs 112 and 114 may differ.

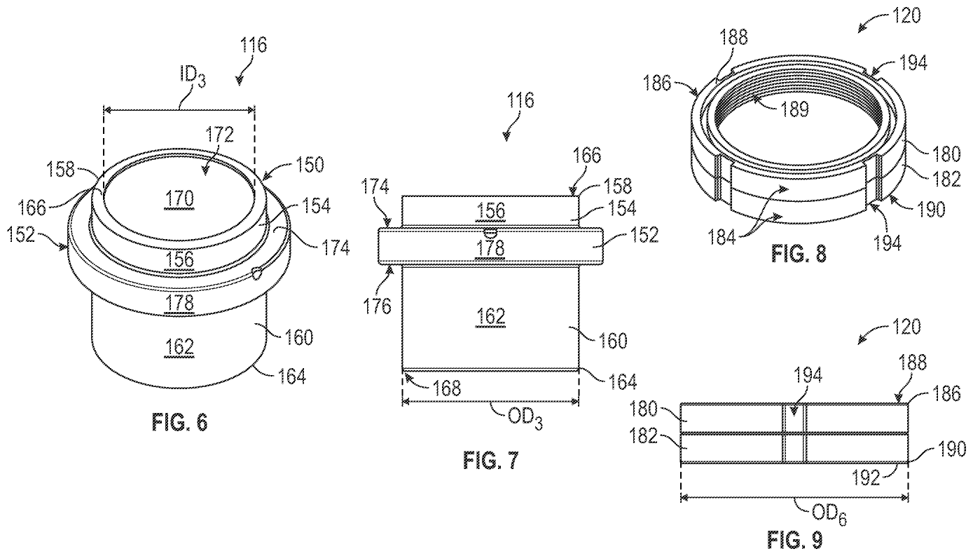

Referring to FIGS. 6 and 7, an embodiment of spring coupler 116 is depicted in a perspective and front view, respectively. In an embodiment, spring coupler 116 comprises a relatively rigid material, such as a polymer. In an embodiment, spring coupler 116 comprises a nylon material; in another embodiment, spring coupler comprises a glass-filled nylon material. In other embodiments, spring couple 116 may comprise metal or other materials.

In an embodiment, and as depicted, spring coupler 116 includes body portion 150 and ring or ridge portion 152. Body portion 150 includes first or upper end 154 with outer surface 156 and first or upper edge 158, and second or lower end 160 with outer surface 162 and second or lower edge 164. Upper edge 158 includes upper edge surface 166; lower edge 164 includes lower edge surface 168. Body portion also includes inner surface 170 defining central cavity 172.

Ring portion 152 is attached to body portion 150 between upper end 154 and lower end 160. In an embodiment, ring portion 152 is integral with body portion 150. Ring portion 152 forms a ring-like structure circumferentially surrounding an exterior portion of body portion 150 and extending radially therefrom. In an embodiment, and as depicted, ring portion 152 is located axially closer to upper end 152 than lower end 160.

In an embodiment, ring portion 152 includes first or upper surface 174, second or lower surface 176 and outer surface 178. In an embodiment, upper surface 174 and lower surface 176 may be substantially flat or planar, and may be parallel to upper and lower edge surfaces 166 and 168.

Body portion 150 defines an outer diameter OD₃ and an inner diameter ID₃. In an embodiment, outer diameter OD₃ of body portion 150 is the same at upper end 154 and lower end 160, and inner diameter ID₃ is the same at upper end 154 and lower end 160. However, in other embodiments, the outer and inner diameters of upper and lower ends may differ from one another to accommodate varying spring sizes and diameters of springs 112 and 114.

Referring to FIGS. 8 and 9, an embodiment of crossover ring 120 is depicted in a perspective view and a side view, respectively. In the depicted embodiment, crossover ring 120 comprises two separate pieces, first or upper threaded ring 180 and second or lower threaded ring 182. In such an embodiment, rings 180 and 182 may be considered “jam nuts” that in combination lock together and hold the rings 180, 182 in place on threaded body 108 (see FIG. 2). In other embodiments, crossover ring 120 may comprise a single ring connectable to body 108. In another embodiment, crossover ring 120 may comprise two pieces that together form a single ring, such as a first semi-circular half ring and a second semi-circular half ring connectable to the first half-ring, both being connected to and held onto body 108 with fasteners or other means.

In an embodiment, crossover ring 120 comprises an aluminum material. In other embodiments, crossover ring 120 comprises a metal other than aluminum. In other embodiments, crossover ring 120 comprises other materials, such as a polymer.

Crossover ring 120, and in an embodiment, both of its rings 180, 182, define an outer diameter of OD₆.

In an embodiment, crossover ring 120 and in an embodiment, each of rings 180 and 182 include inside threads 189 for threading onto external threads 109 of shock body 108 (see also FIG. 2). In an embodiment, each of rings 180 and 182 includes outer surface 184, first or upper end 186 with first or upper surface 188 and second or lower end 190 with second or lower surface 192. In an embodiment, crossover ring 120 and rings 180, 182 define a plurality of grooves 194 configured to receive an adjusting tool for rotating the ring on body 108.

Referring to FIG. 3, depicting shock absorber 100 without springs 112, 114 and crossover ring 120, when shock absorber 100 is assembled, body 108 and piston rod 110 extend between upper end 102 and lower end 104. Upper end 102 is configured to connect to a portion of a vehicle, such as a frame, and lower end 104 is configured to connect to a vehicle wheel axle or related structure. In an embodiment, and as depicted, body 108 includes external threads, though in other embodiments, body 108 may not be threaded.

Adjustable collar 122 is threaded onto, or otherwise connected to body 108 proximal to upper end 102.

Crossover ring 120 is also connected to body 108, and in an embodiment, inside threads 189 of crossover ring 120 (see also FIG. 8) engage external threads 109 of body 108. The axial position of position crossover ring 120 may be set by a user when adjusting the performance characteristics of the shock absorber, as explained further below.

Spring coupler 116 is positioned over portions of body 108, such that body 108 extends through central cavity 170 of spring coupler 116 (see also FIG. 6).

Referring also to FIG. 2, crossover bumper 118, in an embodiment, is attached to body 108 adjacent to, and below, crossover ring 120. Embodiments of crossover bumper 118 and connection to body 108 are discussed further below.

Referring also to FIG. 1, tender spring 112 is positioned over body 108, crossover ring 120, crossover bumper 118, and upper end 154 of spring coupler 116. Further, tender spring 112 is positioned between adjustable collar 122 and ring portion 152 of spring coupler 116. Upper end 130 and uppermost coil 136 are adjacent to, and in contact with, a bottom side of adjustable collar 122. Lower end 132 and lowermost coil 138 are in contact with surface 174 of spring coupler 116. In other words, coil 112 is seated on adjustable collar 122 at an upper end, and on ring 152 at a lower end.

Main spring 114 is positioned over lower end 160, a portion of body 108, and piston rod 110. Upper end 140 and uppermost coil 146 are adjacent to, and in contact with lower surface 176 of ring 152 of spring coupler 116. Lower end 142 and lowermost coil 148 of main spring 114 are in contact with, or seated on, lower spring seat 106 at shock lower end 104.

As such, spring coupler 116 is between tender spring 112 and main spring 114, such that spring couple 116 “couples” the two springs together.

Referring also to FIGS. 6-7, in operation, when an axial force is applied to shock absorber 100 causing it to compress, one or both of springs 112 and 114 compress, causing spring coupler 116 to move toward crossover ring 120 in an upward direction (from lower end 104 toward upper end 102). As force is increased, and tender spring 112 is compressed further, without crossover bumper 118, first end 154 at surface 166 of spring coupler 116 will come into contact with crossover ring 120 at lower end 190 with lower surface 192. At this point, tender spring 112, which is located between adjustable collar 122 and ring 152, cannot compress further, and any further axial compression force will only compress main spring 114.

Consequently, the axial position of crossover ring 120 on body 108 determines an effective spring rate of the dual-spring coil-over shock absorber 100, and changes in the position causes changes in the effective spring rate.

When the compression force is removed, shock absorber 100 extends, or “rebounds.” One or both of springs 112 and 114 extend, moving spring coupler 116 downward and away from crossover ring 120.

As such, during the compression and rebound stages of the operation of shock absorber 100, spring coupler 116 moves up and down, toward and away, from crossover ring 120.

In known dual-spring shock absorbers with a crossover ring, and without the inventive crossover bumper 118, the spring coupler 116 will repeatedly contact the crossover ring 120 as the crossover ring 120 acts as a limit or stop. Furthermore, due to the impact of the spring coupler 116 with crossover ring 120, a noise will often be generated. For example, in some instances, spring coupler 116 moves at a speed of 100 in/s or more, such that impact with crossover ring 120 creates a loud noise, particularly when crossover ring 120 comprises a metal material. Repeated impacts and subsequent noise may not only be unpleasant to a user of the vehicle, but may also cause the user to believe that the shock absorber is malfunctioning or broken. This is particularly true with spring couplers 116 that comprise very rigid, hard materials.

However, in embodiments of shock absorber 100 with a crossover bumper 118, direct contact between spring coupler 116 and crossover ring 120 is avoided, and unwanted noise is eliminated or at least significantly reduced. A further benefit of some embodiments of crossover bumper 118, as described further below is that crossover bumper 118 can prevent springs 112 and/or 114 from rubbing on crossover ring 118, thereby avoiding unwanted wear as well as avoiding cosmetic, or even significant, damage.

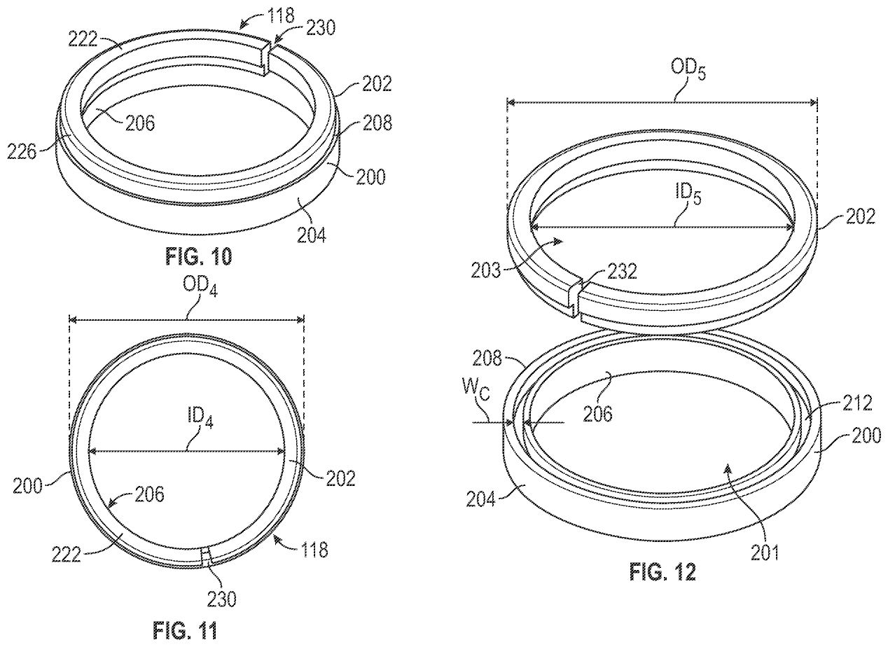

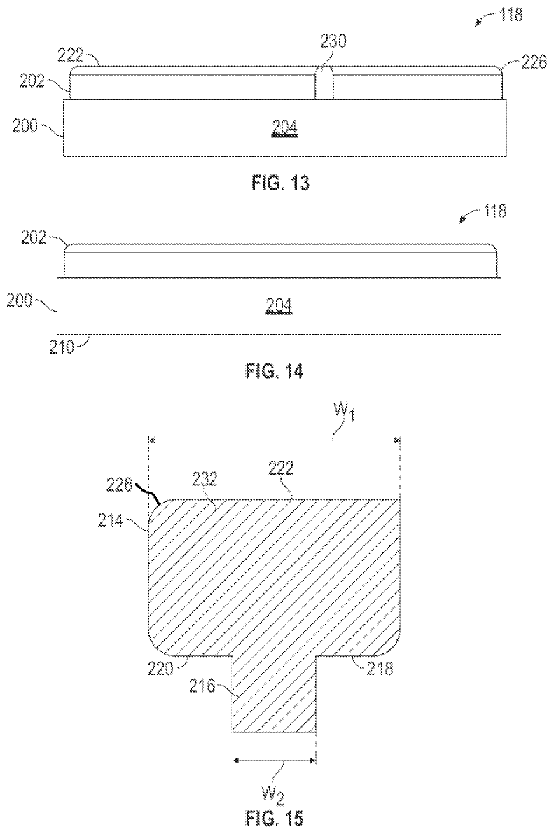

Referring to FIGS. 10-15, an embodiment of crossover bumper 118 is depicted in various views. FIG. 10 is a perspective view of crossover bumper 118; FIG. 11 is a top view of crossover bumper 118; FIG. 12 is an exploded view of crossover bumper 118; FIG. 13 is a front view of crossover bumper 118; FIG. 14 is a rear view of crossover bumper 118; and FIG. 15 is a cross-sectional view of damper ring 202.

In an embodiment, crossover bumper 118 comprises first, or “backer”, ring 200 and second, or “damper”, ring 202. Ring 200 is referred to as a “backer” ring as it provides a backing or base for second or damper ring 202. Ring 202 is referred to as a “damper” ring since it performs a noise and vibration damping function as described further below.

In an embodiment, backer ring 200 comprises a circular ring or ring-shaped body that includes outside circumferential surface 204, inside circumferential surface 206, first or upper side 208 and second or bottom side 210. Backer ring 200 includes outside diameter OD₄ and inside diameter ID₄. In an embodiment, top side 208 defines damper-ring-receiving channel 212 with channel width Wc configured to receive a portion of damper ring 202. In an embodiment, bottom side 210 comprises a generally flat, planar surface and defines central opening 201.

In an embodiment, outside diameter OD₄ of backer ring 200 is larger than outside diameter OD₆ of crossover ring 120. This will allow backer ring 200 to act as a wearable item and become worn by the springs before the crossover rings, which will reduce the noticeable wear on the crossover rings.

Inside circumferential surface 206 may comprise a relatively smooth, curved surface as depicted, and is thusly configured to be friction fit onto body 108. In other embodiments, not depicted, surface 206 may comprise threads configured to engage with threads 109 of body 108 (see FIG. 2).

Backer ring 200 may comprise any of a variety of materials, including polymers such as nylon. In an embodiment, backer ring 200 is relatively stiff and inelastic, with a relatively high modulus of elasticity. In an embodiment, the material comprising backer ring 200 may have a modulus of elasticity in a range of 1 to 30 GPa; in another embodiment, the modulus of elasticity is in a range of 2 to 10 GPa; in another embodiment, the modulus of elasticity is in a range of 2 to 3 GPa; in yet another embodiment, the modulus of elasticity may be approximately 2.7 GPa.

In other embodiments, backer ring 200 may comprise a metal material, such as steel or aluminum. In such an embodiment, backer ring 200 may be a machined metallic backer ring. In an embodiment, a metal backer ring 200 may exhibit a modulus of elasticity in a range of 50 to 250 GPa; in an embodiment, backer ring 200 may have a modulus of elasticity in a range of 60 to 70 GPa; in another embodiment, backer ring 200 may have a modulus of elasticity that is approximately 70 GPa.

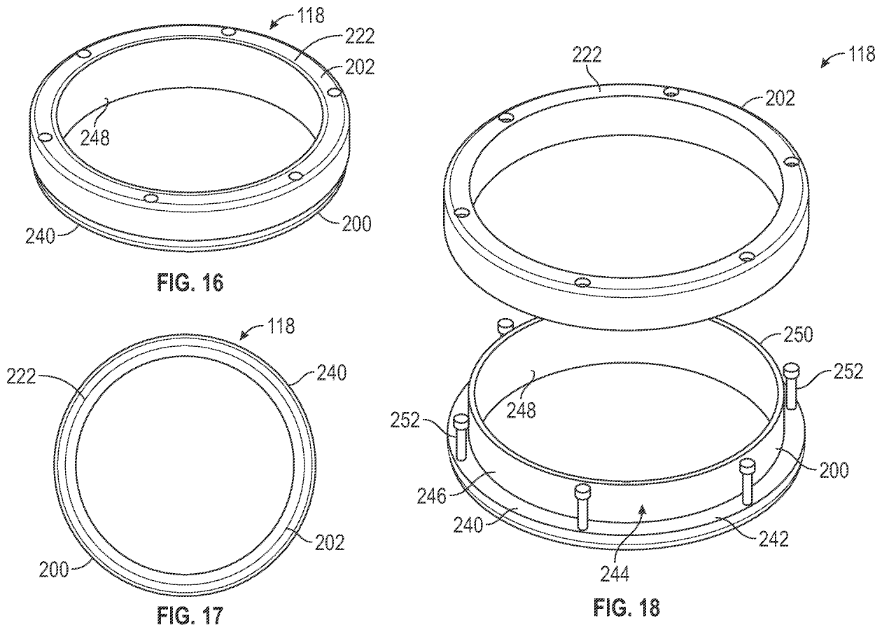

Referring particularly to FIG. 15, damper ring 202 comprises a generally circular ring or ring-shaped body configured to attach to first or upper side 208 of backer ring 200, and defining central opening 203. In an embodiment, damper ring 202 is configured to be partially received into channel 212 to secure damper ring 202. In alternate embodiments, damper ring 202 is simply affixed to, or bonded to, upper side 202 of backer ring 200 with an adhesive, such that backer ring 202 may not include channel 212. In yet another embodiment, damper ring 202 is overmolded onto backer ring 200, as described in detail below with respect to FIGS. 16-20.

Damper ring 202 defines an inner diameter ID₅, and an outer diameter OD₅. In an embodiment, ID₅ is less than the inner diameter ID₄ of backer ring 200. In one such embodiment, ID₅ of damper ring 202 is slightly smaller than, or less than, an outer diameter of body 108 of shock absorber 100. In such an embodiment, resilient damper ring 202 is configured to hold crossover bumper 118, including backer ring 200 and damper ring 202, in position on body 108 via friction fit.

In an embodiment, outer diameter OD₅ of damper ring 202 is less than OD₄ of backer ring 200. In such an embodiment, springs 112 and 114 are less likely to contact damper ring 202, thereby minimizing wear and possible damage to damper ring 202.

In the embodiment depicted, damper ring 202 in cross section forms a “T” shape and includes first portion 214 attached to second portion 216. In an embodiment first portion 214 and second portion 216 are integrally formed, though in other embodiments may comprise separate components attached together. First portion 214 in an embodiment includes a width W1 that is greater than a width W2 of second portion 216.

Damper ring 202 also includes inner lower surface or side 218, outer lower surface or side 220, first or upper surface or side 222, and optionally, outside rounded or chamfered edge 226.

In an embodiment, and as depicted, damper ring 202 defines a gap or break or split 230 and thusly includes opposing end faces 232. In such an embodiment, damper ring is generally circular, but is not continuous circumferentially. In an embodiment, split 230 defines a gap between end faces 232. In another embodiment, split 230 does not define a gap or defines only a very small gap, so that all or substantially all of end faces 232 abut and are in contact with each other. In other embodiments, damper ring 202 may not include split 230, and may be circumferentially continuous. However, an advantage in having a split 230, as described further below, is that damper ring 202 may be installed onto shock body 108 while shock absorber 100 remains on the vehicle, by wrapping damper ring 202 around shock body 108 and then fitting damper ring to backer ring 200. Damper ring 202 is then easily serviceable as shock absorbers 100 do not need to be disassembled from the springs to change out damper ring 202. As such, damper ring 202 might be considered a “sacrificial wear” item to dampen noise, protect crossover ring 120, and be replaced after becoming worn.

In an embodiment, damper ring 202 comprises a highly-elastic or resilient material, such as an elastomer or rubber. Other suitable resilient materials are contemplated. In an embodiment, damper ring 202 is relatively flexible and elastic, with a relatively low modulus of elasticity. In an embodiment, the material comprising damper ring 202 may have a modulus of elasticity in a range of 0.001 to 1.0 GPa; in another embodiment, the modulus of elasticity is in a range of 0.1 to 1 GPa; in another embodiment, the modulus of elasticity is in a range of 0.01 to 0.10 GPa.

Referring also to FIG. 2, when assembled onto body 108 of shock 100, crossover bumper 108 is fitted over body 108, with backer ring 200 facing upward toward, and adjacent to, crossover ring 120. Damper ring 202 is facing downward toward lower end 104 of shock absorber 100.

In operation, as spring coupler 116 moves up shock body 108 during shock compression, shock coupler 116 will strike damping ring 202, which sits against backer ring 200, which directly sits against crossover ring 120. Damping ring 202 will dampen the sound created by the striking of spring coupler 116 against cross over ring 120. A first purpose of backer ring 200 is to provide a rigid surface for damping ring 202 to sit flat against, and to support, during impact. A second purpose of backer ring 200, in an embodiment, and as described above, is to protect crossover ring 120 from contacting springs 112 and/or 114.

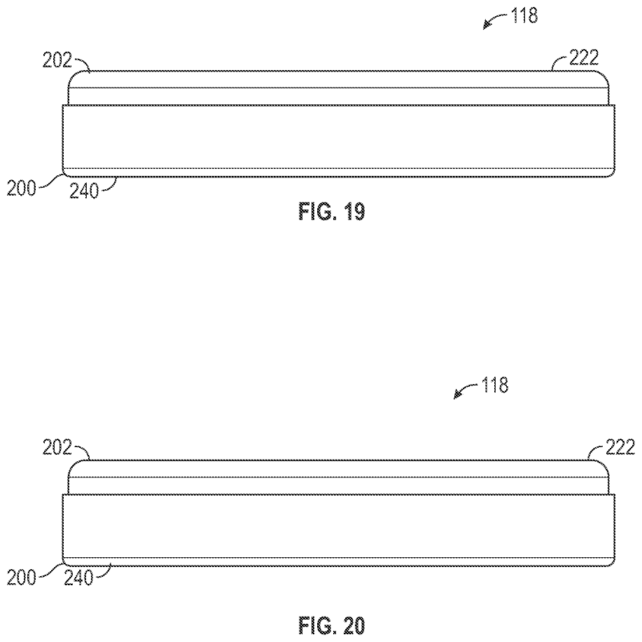

Referring to FIGS. 16-20, an overmolded version of crossover bumper 118 is depicted in various views. FIG. 16 is a perspective view of overmolded crossover bumper 118; FIG. 17 is a top view overmolded crossover bumper 118; FIG. 18 is an exploded view of overmolded crossover bumper 118; FIG. 19 is a front view of overmolded crossover bumper 118; and FIG. 20 is a side or rear view of overmolded crossover bumper 118.

In this embodiment, crossover bumper 118 still includes backer ring 200 and damper ring 202. However, in this embodiment, damper ring 202 is overmolded onto backer ring 200, and rings 200, 202 have some structural changes as compared to the embodiments described above with respect to FIGS. 10-15.

In this embodiment, backer ring 200 includes base portion 240 with upper surface 242, inner ridge or wall 244 with outside surface 246, inside surface 248 and upper edge 250. Backer ring 200 may also include structural support pins 252 used in the overmolding process.

As depicted, inner wall 244 projects upward and away from base 240 of backer ring 200 and its surface 242. Surface 242 circumferentially surrounds inner wall 244. In an embodiment, backer ring 200 is a molded device, such that wall 244 and base 240 are integrally formed.

Damping ring 202 is molded over backer ring 200, such that damper ring 202 is formed onto outside surface 246 of inner wall 244 and surface 242 of base 240. In an embodiment, upper surface 222 of damper ring 202 is approximately in the same plane as upper edge 250 of backer ring 200. In other embodiments, damper ring 202 projects upwardly slightly further than edge 250.

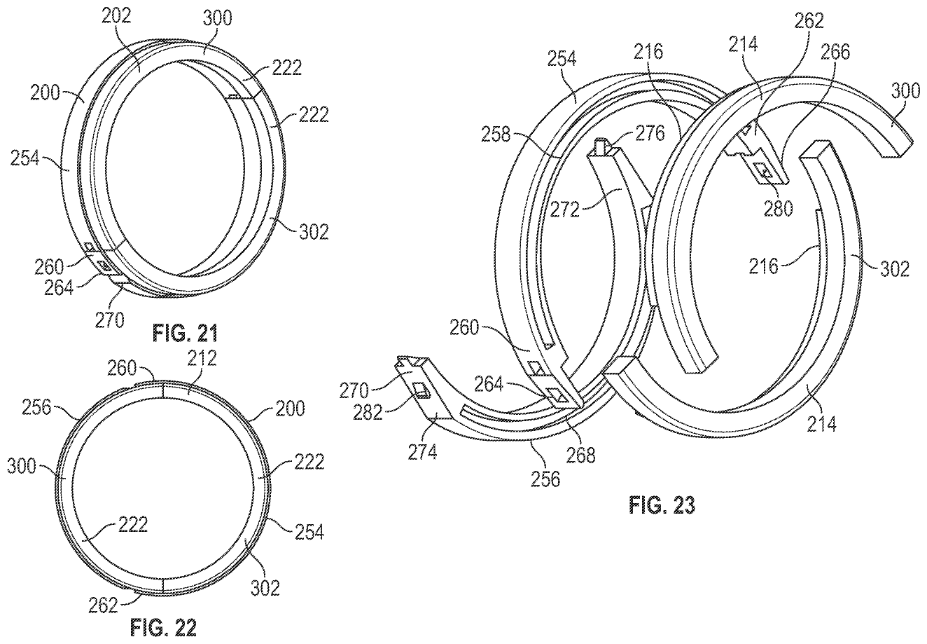

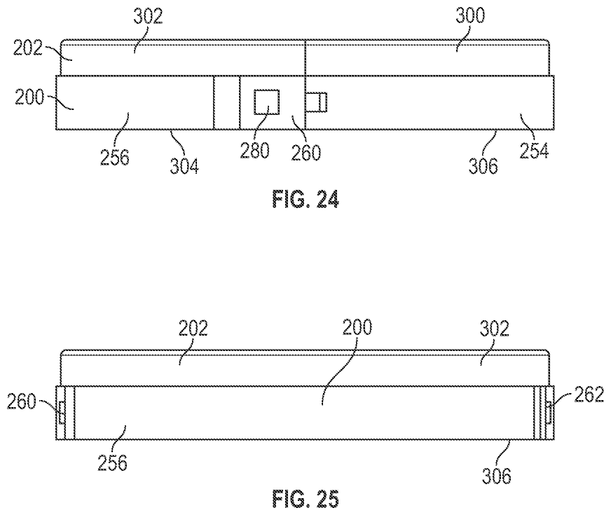

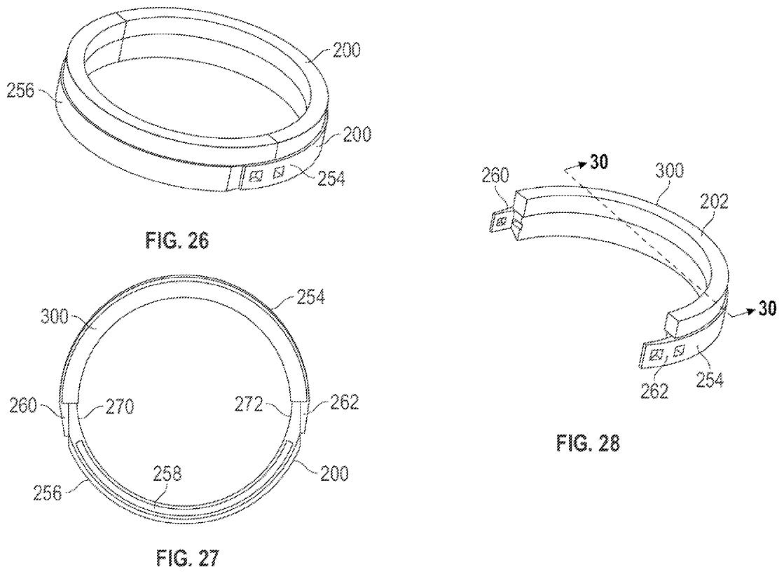

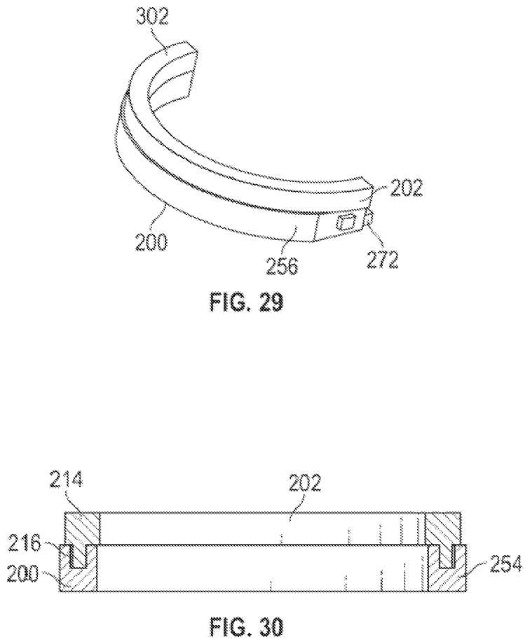

Referring to FIGS. 21-30, another embodiment of crossover bumper 118 is depicted. In this embodiment, either or both of backer ring 200 and damper ring 202 comprise multiple pieces that together form a snap ring. FIG. 21 is perspective view of a multi-piece crossover bumper 118; FIG. 22 is a top view of crossover bumper 118; FIG. 23 is an exploded view of crossover bumper 118; FIG. 24 is a front view of crossover bumper 118; FIG. 25 is a side view of crossover bumper 118; FIG. 26 is a second perspective view of crossover bumper 118; FIG. 27 is a top view of crossover bumper 118 with a portion of damper ring 202 removed; FIG. 28 is a perspective view of a first semi-circular portion of crossover bumper 118; FIG. 29 is a perspective view of a second semi-circular portion of crossover bumper 118; and FIG. 30 is a cross sectional view of the first semi-circular portion of crossover bumper 118.

As depicted, this multi-piece embodiment of crossover bumper 118 also includes backer ring 200 and damper ring 202. In an embodiment, backer ring 200 comprises multiple portions or pieces, including first semi-circular portion 254, which may be approximately a half portion, and second semi-circular portion 256, which may be another approximately half portion.

First semi-circular portion 254 defines damper-ring-receiving channel 258 and includes first end 260 and second end 262. First end 260 includes first fastener portion 264; second end 262 includes second fastener portion 266. In other embodiments, backer ring 200 may include more than two portions, such as three portions or more to accommodate various shock absorbers 100. Damper-ring receiving channel 258 may extend less than the entire central circumference of first semi-circular portion 254 to allow tapering of first and second ends 260, 262.

Second semi-circular portion 256 defines damper-ring-receiving channel 268 and includes first end 270 and second end 272. First end 270 includes first fastener portion 274; second end 272 includes second fastener portion 276. Damper-ring receiving channel 268 may extend less than the entire central circumference of second semi-circular portion 256 to allow tapering of first and second ends 270, 272.

First semi-circular portion 254 is configured to attach to second semi-circular portion 256 to form a continuous ring structure. First end 260 is configured to connect to first end 270, and second end 262 is configured to connect to second end 272.

In an embodiment, first fastener portion 264 of first semi-circular portion 254 is configured to fasten or connect to first fastener portion 274 of second semi-circular portion 256; second fastener portion 266 is configured to fasten or connect to second fastener portion 276 of second semi-circular portion 256.

Ends 260, 262, 270 and 272 and respective fastener portions 264, 266, 274 and 276 may comprise various structures and devices for connecting semi-circular portions 254 and 256 to one another. In an embodiment, ends 260, 262, 270 and 272 each define a tapering thickness, such that ends 260 and 270 overlap one another and ends 262 and 272 overlap each other, as depicted. In an embodiment, fastening portions 264 and 266 include one or more openings 280 to receive one or more projections 282 of fastening portions 274 and 276, respectively. The projections fitting into the openings may form a snap fit or other such fit or connection.

Damper ring 202, in this embodiment, comprises a first semi-circular damper-ring portion 300 and second semi-circular damper-ring portion 302. Damper ring 202, in this embodiment, is substantially similar to damper ring 202 as described above with respect to FIGS. 10-15, with at least the exceptions that damper ring 202 of the embodiment of FIGS. 21-30 is a multi-piece ring, split into two semi-circular portions 300 and 302, which may be approximately half circle portions.

Damper ring portions 300 and 302 also may each be “T” shaped in cross section along a majority of its arc length, each having a first or upper portion 214 and a second or lower portion 216. In such an embodiment, first portions 216 of damper ring portions 300 and 302 are configured to be received into channels 258 and 268 of backer ring 200. In an embodiment, first portion 214 may extend circumferentially further on each end (see in particular, FIG. 23), such that respective ends of damper ring portions 300 and 302 abut one another when assembled to first and second semi-circular portion 254, 256 of backer ring 200. In the embodiments depicted in FIGS. 21-25, damper ring portions 300 and 302 include rounded or chamfered outside edges, similar to the embodiments of FIG. 15, while in the embodiments depicted in FIGS. 26-30, the outside edges of damper ring portions 300 and 302 are depicted as squared-off edges. Embodiments of damper ring portions 300 and 302 may include either rounded edges or squared-off edges, as depicted in the various figures.

In other embodiments, damper ring portions 300 and 302 may be overmolded onto backer ring portions 254, 256, similar to the embodiments described above with respect to FIGS. 16-20.

As described above, in the embodiment of FIGS. 21-30, crossover bumper 118 forms a snap ring device. “Snap ring” describes how two pieces of backer ring 200 with damper ring 202 are snapped together using extruded features on the backer ring portions 254, 256 to interlock around a shaft, i.e., body 108 of shock absorber 100. Two halves of the crossover bumper 118 are can be placed around shock body 108, snapping together to form a full ring around shock body 108. These rigid snap-ring structures of backer ring 200 will then have damper ring portions 300 and 302 press fit into channels 258 and 268, respectively, or will have damper ring portions 300 and 302 overmolded onto backer ring portions 254, 256. In either configuration, the rigid snap-ring face of backer ring portions 254 and 256, namely, surfaces 304 and 306 (see FIG. 24) will face against an existing crossover ring 120, while the damping material of damper ring 202 will face lower end 104 of shock absorber 100, and spring coupler 116.

As spring coupler 116 moves up shock body 108 during shock compression, shock coupler 116 will strike the damping face or surface 222 of the snap ring. This will dampen the sound created by shock coupler 116 striking crossover ring 120. As described above with respect to the other embodiments, backer ring 200 forming the snap ring feature of crossover bumper 118 can be created to have a larger outer diameter (OD) than the crossover 188 OD to allow the snap ring to be a wearable component and reduce the wear on the actual threaded crossover ring 120. As also described above with respect to the other embodiments, the inner diameter (ID) of the damping portion, damper ring 202, of the snap-ring embodiment of crossover bumper 118, may be slightly smaller than the OD of shock body 108 to provide a friction fit and keep crossover bumper 118 from moving axially along shock body 108 after placement.

The snap ring embodiment of crossover bumper 118 is particularly useful as it is easily serviceable. The two-piece snap ring structure means it can be installed or removed onto a shock absorber 100 while the shock is still on a vehicle, and therefore requires no disassembly of the shock from the springs. Such a crossover bumper 118 can be easily installed by a user by taking the two bumper halves and snapping them around shock body 108 beneath crossover ring 120. If the damper ring 202 halves 300, 302 are over molded onto the snap together rigid pieces that are backer ring portions 254, 256, then there are only two components to assemble onto shock body 108. If the damper ring halves 300, 302 are press fit onto the rigid snap rings, as depicted in FIGS. 21-30, there are still only four total components to assemble.

Referring to FIGS. 31-36, another embodiment of crossover bumper 118 is depicted. In this embodiment, crossover bumper 118 may function as a first jam nut of a crossover ring 120 that comprises two jam nuts. In other words, crossover bumper 118 in this embodiment is a substitute for one of two jam nuts of a crossover ring 120.

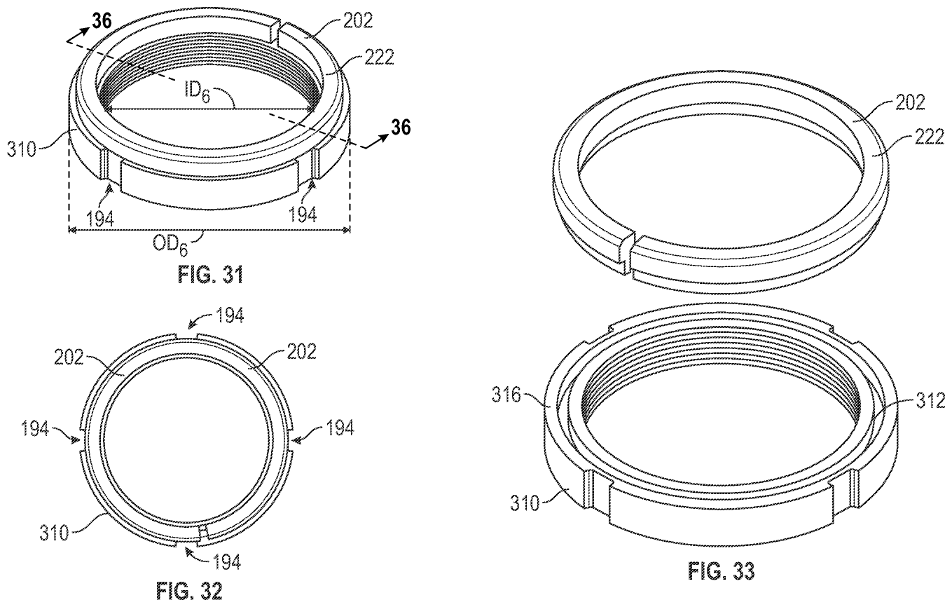

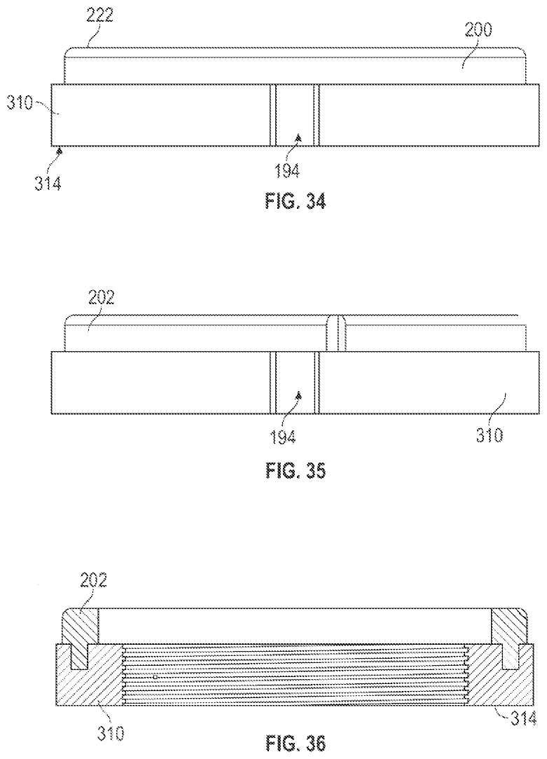

FIG. 31 is a perspective view of crossover bumper 118; FIG. 32 is a top view of crossover bumper 118; FIG. 33 is an exploded view of crossover bumper 118; FIG. 34 is a front view of crossover bumper 118; FIG. 35 is a side view of crossover bumper 118; and FIG. 36 is cross-sectional view of crossover bumper 118.

In this embodiment, crossover bumper 118 includes jam nut portion 310 with damper ring 202. Jam nut portion 310 replaces backer ring 200 that was present in embodiments of crossover bumper 118 described above. Referring also to FIGS. 8 and 9, this embodiment of crossover bumper 118 may replace a portion of the crossover ring, such as replacing lower threaded ring/jam nut 182 of the crossover ring 118 depicted in FIGS. 8-9. However, it will be understood that this embodiment of crossover bumper 118 may be used by itself as a standalone crossover ring, or in conjunction with other types of crossover rings that may or may not comprise a pair of jam nuts.

Jam nut portion 310 is substantially similar to second threaded ring 182 as depicted and described in FIGS. 8 and 9 above. However, unlike second threaded ring 182, jam nut portion 310 defines damper-ring receiving channel 312.

In an embodiment, jam nut portion 310 defines outer diameter OD₆ and inner diameter ID₆. Jam nut portion 310 includes first or bottom surface 314, second upper surface 316, outer surface 318 and inner surface 320. First surface 314 may be substantially flat, and configured to abut another jam nut of crossover ring 120, such as threaded ring 180. Second surface 316 defines damper-receiving channel 312 for receiving damper ring 202. Outer surface 318 may form one or more grooves 194. Inside surface 320 may include threads configured to engage with external threads of shock body 108, so that jam nut portion 310 may be threadably engaged with shock body 108 and shock absorber 100.

Damper ring 202 in this embodiment may be substantially the same as the press-fit damper ring 202 of the embodiment of FIGS. 10-15 as described above, with a portion of ring 202 fitting into channel 312. In other embodiments, damper ring 202 may be overmolded onto jam nut portion 310, similar to damper ring 202 as described above with respect to FIGS. 16-20. In other embodiments, damper ring 202 may be affixed to jam nut 310 in another manner, such as via an adhesive.

Crossover bumper 118 as depicted in FIGS. 31-36 provides the dual advantages of fewer parts to manufacture, and fewer parts to install.

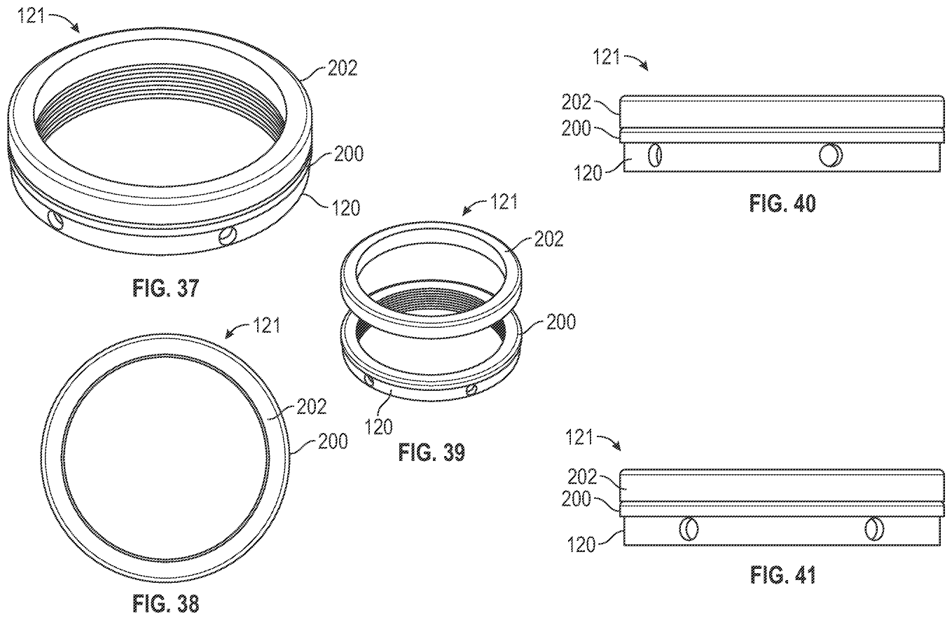

Referring to FIGS. 37-41, in another embodiment that provides the advantages of fewer parts, crossover bumper 118 is integrated into crossover ring 120 to form a damping crossover ring 121. FIG. 37 is a perspective view of damping crossover ring 121; FIG. 38 is a top view of damping crossover ring 121; FIG. 39 is a partially-exploded view of damping crossover ring 121; FIG. 40 is a front view of damping crossover ring 121; and FIG. 41 is a side view of damping crossover ring 121.

Damping crossover ring 121, in an embodiment, includes crossover ring 120, backer or base 200 and damper ring 202. In this embodiment, crossover ring 120 may comprise a threaded aluminum material, though other materials are contemplated. Further, in an embodiment, and as depicted, crossover ring 120 may comprise a single ring, or in other embodiments, may comprise a pair of rings, such as two threaded rings, similar to the two threaded jam nut version of crossover ring 120 described above.

In an embodiment, damping crossover ring 121 includes backer ring 200 that is substantially the same as depicted and described above with respect to FIGS. 10-15, or FIGS. 16-20. In other embodiments, “backer ring” 200 may comprise a base portion that is integrated or formed into crossover ring 120, and manufactured of the same material as the crossover ring 120 itself. In an embodiment, whether a separate component, or integrated into crossover ring 120, backer ring 120 may define an outer diameter that is greater than an outer diameter of crossover ring 120, as also described above in other embodiments of backer ring 200.

In an embodiment where backer ring 200 is a separate component, backer ring 200 may be attached to crossover ring 120 by various means, including through the use of an adhesive, welding, fasteners, and so on.

Damper ring 200 is attached to backer ring 200 by any of the methods described above with respect to other embodiments, including with an adhesive, press fit, overmolding, and so on.

In yet another embodiment, damper ring 202 is simply affixed directly to crossover ring 120 without a backer ring 200 via an adhesive, press fit, overmolding or other fixation methods.

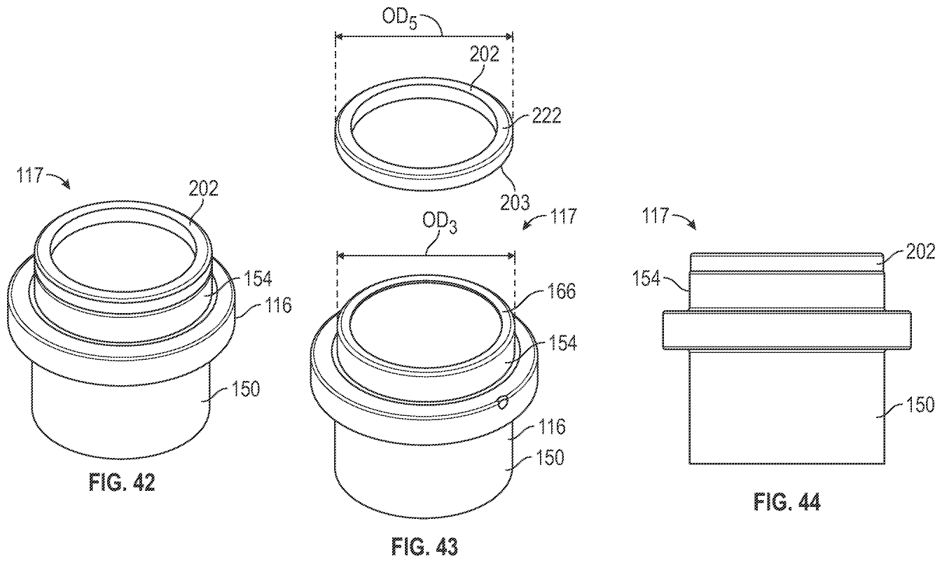

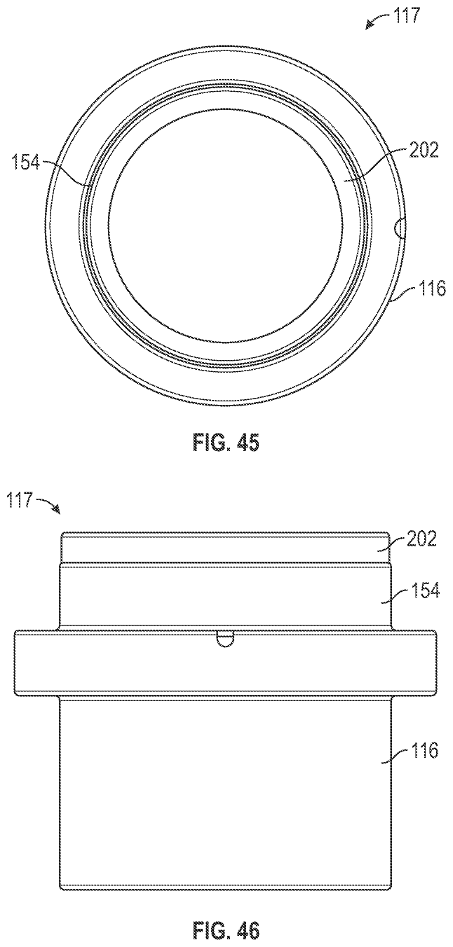

Referring to FIGS. 42-46, an embodiment of damping spring coupler 117 is depicted. FIG. 42 is a perspective view of damping spring coupler 117; FIG. 43 is an exploded view of damping spring coupler 117; FIG. 44 is front view of damping spring coupler 117; FIG. 45 is a top view of damping spring coupler 117; and FIG. 46 is a side view of damping spring coupler 117.

As described above, when shock absorber 100 is compressed, shock coupler 116 may strike crossover ring 120, causing a noisy and potentially destructive impact. Embodiments of crossover bumper 118 remedy such a problem. An alternative to crossover bumper 118 is damping spring coupler 117.

As depicted, and in an embodiment, damping spring couple 117 includes spring coupler 116, as described above, and damper ring 202.

In an embodiment, damper ring 202 is substantially the same as described above with respect to FIGS. 10-14. However, in an embodiment, and as depicted, damper ring 202 may not have a split 230, but rather, may form a contiguous ring shape having an outside diameter OD₅. In an embodiment, OD5 of damper ring 202 may be slightly less than outer diameter OD₃ of first end 154 of body portion 150. In such an embodiment, damper ring 202, with its resilient material is less likely to contact tender spring 112, thereby avoiding damage to damper ring 202.

In an embodiment, damper ring 202 may include substantially flat surface 223 that is parallel to first surface 222, and that is in contact with first surface 166 of spring coupler 116. In such an embodiment, damper ring 202 may be attached to first surface 166 via bonding, including applying an adhesive between ring 202 and spring couple 116.

In another embodiment, top surface 166 of spring coupler 116 defines a damper-receiving channel (not depicted) similar to channel 212 of backer ring 200 that is configured to receive a portion of damper ring 212, leaving another portion above surface 166 (see the similarly-described structure of FIGS. 10-15).

In yet another embodiment, damper ring 202 is overmolded onto first end 154 at surface 166, similar to how damper ring 202 was described as being overmolded onto backer ring 200 with respect to FIGS. 16-20.

When damping spring coupler 117 is installed onto shock absorber 100, and strikes crossover ring 120, resilient, exposed surface 222 will impact crossover ring 120, rather than surface 166 of rigid spring coupler 116, eliminating unwanted noise.

The following clauses illustrate the subject matter described herein.
Clause 1: A crossover bumper for damping noise in a dual-spring shock absorber that includes a spring coupler and a crossover ring. The crossover bumper includes: a first ring comprising a first material forming a ring-shaped body that includes a first side and a second side facing opposite to the first side, and that defines a central opening, an inside diameter and an outside diameter; and a second ring attached to the first side of the first ring and comprising a second material forming a ring-shaped body defining a central opening aligned with the central opening of the first ring, an inside diameter and an outside diameter; wherein the first material has a modulus of elasticity that is greater than a modulus of elasticity of the second material.
Clause 2. The crossover bumper of clause 1, wherein the outer diameter of the second ring is less than the outer diameter of the first ring.
Clause 3. The crossover bumper of clause 1, wherein the inner diameter of the second ring is less than the inner diameter of the first ring.
Clause 4. The crossover bumper of clause 1, wherein the first material comprises a polymer material, and the second material is an elastomeric material.
Clause 5. The crossover bumper of clause 1, wherein the second ring is press fit into a channel defined by the first side of the first ring.
Clause 6. The crossover bumper of clause 1, wherein the second ring is overmolded onto the first ring.
Clause 7. The crossover bumper of clause 1, wherein the first modulus of elasticity is in a range of 1.0 to 3.0 GPa and the second modulus of elasticity is in a range of 0.01 to 0.1 GPa.
Clause 8. The crossover bumper of clause 1, wherein the second ring defines a split forming a gap between ends of the second ring.
Clause 9. A crossover bumper for damping noise in a dual-spring shock absorber that includes a shock body, a spring coupler and a crossover ring. The crossover bumper includes: a first multi-portion backer ring comprising a first material that includes a first semi-circular portion having a first end and a second end, and a second semi-circular portion having a first end and a second end, the first end of the second semi-circular portion connectable to the first end of the first semi-circular portion, and the second end of the second semi-circular portion connectable to the second end of the first semi-circular portion, such that the first semi-circular portion and the second semi-circular portion are connectable to form a ring shape; and a second multi-portion damper ring comprising a second material, the second material being different from the first material, the second multi-portion including: a first semi-circular portion configured to connect to the first semi-circular portion of the first multi-portion ring, and a second semi-circular portion configured to connect to the second semi-circular portion of the first multi-portion ring.
Clause 10. The crossover bumper of clause 9, wherein the first multi-portion backer ring defines a channel, and a portion of the second multi-portion damper ring is configured to fit into the channel.
Clause 11. The crossover bumper of clause 9, wherein a connection formed by the first end of the first semi-circular portion of the backer ring and the first end of the second semi-circular portion of the backer ring forms a snap-fit connection.
Clause 12. The crossover bumper of clause 9, wherein the first end of the first semi-circular portion of the backer ring defines a tapered thickness and the first end of the second semi-circular ring of the backer ring defines a tapered thickness, and the first ends are configured to overlap when connected to one another.
Clause 13. The crossover bumper of clause 9, wherein an arc length of the first semi-circular portion of the backer ring is longer than an arc length of the first semi-circular portion of the damper ring.
Clause 14. A damping spring coupler for a dual-spring shock absorber. The damping spring coupler includes: a spring coupler portion for coupling a first spring and a second spring of the dual-shock absorber that includes: a body portion having a first end and a second end, the second end having an end surface, the body portion defining a central channel; a ring portion between the first end and the second end; and a damper ring affixed to the end surface of the second end of the body portion.
Clause 15. The damping spring coupler of clause 14, wherein the damper ring portion comprises a material with a lower modulus of elasticity as compared to the spring coupler portion.
Clause 16. The damping spring coupler of clause 14, wherein the damper ring portion comprises an elastomeric material.
Clause 17. The damping spring coupler of clause 14, wherein the damper ring portion is overmolded onto the spring coupler portion.
Clause 18. The damping spring coupler of clause 14, wherein the damper ring portion is press fit onto the spring coupler portion.
Clause 19. A dual-spring shock absorber including the crossover bumper of clause 1.
Clause 20. A dual-spring shock absorber including the crossover bumper of clause 9.

The invention is not restricted to the details of the foregoing embodiment (s). The invention extends to any novel one, or any novel combination, of the features disclosed in this specification (including any incorporated by reference references, any accompanying claims, abstract and drawings), or to any novel one, or any novel combination, of the steps of any method or process so disclosed. The above references in all sections of this application are herein incorporated by references in their entireties for all purposes.

While the aforementioned particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A crossover bumper for damping noise in a dual-spring shock absorber that includes a spring coupler and a crossover ring, comprising:
a first ring comprising a first material forming a ring-shaped body that includes a first side and a second side facing opposite to the first side, and that defines a central opening, an inside diameter and an outside diameter; and
a second ring attached to the first side of the first ring and comprising a second material forming a ring-shaped body defining a central opening aligned with the central opening of the first ring, an inside diameter and an outside diameter;
wherein the first material has a modulus of elasticity that is greater than a modulus of elasticity of the second material.

2. The crossover bumper of claim 1, wherein the outer diameter of the second ring is less than the outer diameter of the first ring.

3. The crossover bumper of claim 1, wherein the inner diameter of the second ring is less than the inner diameter of the first ring.

4. The crossover bumper of claim 1, wherein the first material comprises a polymer material, and the second material is an elastomeric material.

5. The crossover bumper of claim 1, wherein the second ring is press fit into a channel defined by the first side of the first ring.

6. The crossover bumper of claim 1, wherein the second ring is overmolded onto the first ring.

7. The crossover bumper of claim 1, wherein the first modulus of elasticity is in a range of 1.0 to 3.0 GPa and the second modulus of elasticity is in a range of 0.01 to 0.1 GPa.

8. The crossover bumper of claim 1, wherein the second ring defines a split forming a gap between ends of the second ring.

9. A crossover bumper for damping noise in a dual-spring shock absorber that includes a shock body, a spring coupler and a crossover ring, comprising:
a first multi-portion backer ring comprising a first material, including:
a first semi-circular portion having a first end and a second end, and
a second semi-circular portion having a first end and a second end, the first end of the second semi-circular portion connectable to the first end of the first semi-circular portion, and the second end of the second semi-circular portion connectable to the second end of the first semi-circular portion, such that the first semi-circular portion and the second semi-circular portion are connectable to form a ring shape; and
a second multi-portion damper ring comprising a second material, the second material being different from the first material, the second multi-portion including:
a first semi-circular portion configured to connect to the first semi-circular portion of the first multi-portion ring, and
a second semi-circular portion configured to connect to the second semi-circular portion of the first multi-portion ring.

10. The crossover bumper of claim 9, wherein the first multi-portion backer ring defines a channel, and a portion of the second multi-portion damper ring is configured to fit into the channel.

11. The crossover bumper of claim 9, wherein a connection formed by the first end of the first semi-circular portion of the backer ring and the first end of the second semi-circular portion of the backer ring forms a snap-fit connection.

12. The crossover bumper of claim 9, wherein the first end of the first semi-circular portion of the backer ring defines a tapered thickness and the first end of the second semi-circular ring of the backer ring defines a tapered thickness, and the first ends are configured to overlap when connected to one another.

13. The crossover bumper of claim 9, wherein an arc length of the first semi-circular portion of the backer ring is longer than an arc length of the first semi-circular portion of the damper ring.

14. A damping spring coupler for a dual-spring shock absorber, comprising:
a spring coupler portion for coupling a first spring and a second spring of the dual-shock absorber, including:
a body portion having a first end and a second end, the second end having an end surface, the body portion defining a central channel;
a ring portion between the first end and the second end; and
a damper ring affixed to the end surface of the second end of the body portion.

15. The damping spring coupler of claim 14, wherein the damper ring portion comprises a material with a lower modulus of elasticity as compared to the spring coupler portion.

16. The damping spring coupler of claim 14, wherein the damper ring portion comprises an elastomeric material.

17. The damping spring coupler of claim 14, wherein the damper ring portion is overmolded onto the spring coupler portion.

18. The damping spring coupler of claim 14, wherein the damper ring portion is press fit onto the spring coupler portion.

19. A dual-spring shock absorber including the crossover bumper of claim 1.

20. A dual-spring shock absorber including the crossover bumper of claim 9.
